(19) United States
(12) Patent Application Publication
(10) Pub. No.: US 2005/0090969 A1
(43) Pub. Date: Apr. 28, 2005

(54) Systems and methods for managing airport operations

(75) Inventors: Michael P. Siok, Arnold, MD (US); Gary P. Gambarani, Annapolis, MD (US); Richard P. Stead, Annapolis, MD (US); Shimon Y. Weichbrod, Baltimore, MD (US)

Correspondence Address: OLIFF & BERRIDGE, PLC, P.O. BOX 19928, ALEXANDRIA, VA, 22320, US

(73) Assignee: ARINC INCORPORATION, Annapolis, MD (US)

(21) Appl. No.: 10/689,984

(22) Filed: Oct. 22, 2003

(51) Int. Cl. G06F 17/00; G08G 5/00

(52) U.S. Cl. 701/120; 701/10; 340/958

(57) ABSTRACT

Status information on plane, passenger, cargo, crew, fuel, food, baggage, maintenance, weather and any other process used to manage airport operations, including expediting aircraft turnaround time for takeoff, is gathered into a common decision support database. The system includes decision support tools to increase the sharing of information between airline, airport, contractors and the Federal Aviation Administration (FAA), to more efficiently and safely manage the service, maintenance and operations of aircraft.

### BACKGROUND OF THE INVENTION

1. Field of Invention

This invention relates to systems and methods for managing airport operations. More specifically, this invention relates to an operations management tool for collaborative decision support for airline personnel through shared tactical operational information.

2. Description of Related Art

Many complicated activities must be coordinated to keep an airport and the airlines that use it running efficiently. Planes, passengers, cargo, crews, fuel, food, baggage, maintenance, weather information and many other essentials must be routed to the optimal place at the optimal time to complete flights at minimal cost. To coordinate the routing of these items information on the status of each activity must be gathered. The gathered status information must then be analyzed and/or displayed in a usable fashion so that individuals and/or control systems can use it to make the decisions needed to operate the airport and airlines.

There are many existing techniques for gathering much of the necessary data. U.S. Pat. No. 5,216,611 by McElreath ('611), U.S. Pat. No. 6,246,320 by Monroe ('320), and U.S. Pat. No. 6,392,692 by Monroe ('692), incorporated herein by reference in their entirety, disclose several systems and methods for tracking the position of one or more aircraft. U.S. Patent Application Publication No. 2002/0173883 by Ezaki incorporated herein by reference in its entirety, discloses a system, method and software for obtaining passenger and aircraft status.

There are many existing techniques for displaying aircraft location data for analysis and decision support. U.S. Pat. No. 5,913,912 by Nishimura et. al. ('912), U.S. Pat. No. 6,278,965 by Glass et. al. ('965), U.S. Pat. No. 6,314,363 by Pilley et. al. ('363), and U.S. Pat. No. 6,246,342 by Vandervoorde et. al. ('342) incorporated herein by reference in their entirety, disclose several systems and methods for managing the collected aircraft location data. The '912, '965, '363, and '342 patents use various database configurations and display methods to support the decisions required to manage the movement of aircraft.

### SUMMARY OF THE INVENTION

As demonstrated in the above patents, systems and methods exist to gather status information on aircraft location and passengers and manage the movement of aircraft. The airport authority and each airline at an airport often use different systems and methods to gather such information making it difficult to share information. In addition, the status of crews, fuel, food, baggage, maintenance and de-icing are presently collected using many diverse methods making it difficult to integrate this information into the high level decision process during an aircraft “turnaround”. Communication of decisions to the various organizations supporting aircraft turnaround is also difficult with existing methods and systems.

This invention provides systems and methods that gather status information on plane, passenger, cargo, crew, fuel, food, baggage, maintenance, weather and any other process used to manage airport operations, including expediting aircraft turnaround time for takeoff, into a common decision support database.

The systems and methods of this invention provide decision support tools to increase the sharing of information between airline, airport, contractors and the Federal Aviation Administration (FAA), to more efficiently and safely manage the service, maintenance and operations of aircraft. For example, command, control and communications capabilities are displayed as real-time information regarding aircraft scheduled to arrive and depart from the airport.

This invention separately provides a situation graphical user interface for accessing and viewing status information stored in the decision support database and reconfiguring airport resources.

This invention separately provides a ground control graphical user interface used to manage airport ground traffic.

This invention separately provides systems and methods that transmit decisions and status to the separate organizations and functions supporting aircraft turnaround at an airport.

This invention separately provides decision support capabilities, command and control functions, report capabilities, reduction in operating costs and increased situational awareness, i.e., safety. The systems and methods of the invention also fuse realtime event data from multiple sources, maintain historical logs of all events, maintain performance information and integrate communications, such as data link, voice, multiple data sources, and communications between other airline applications.

In various exemplary embodiments, the systems and methods according to this invention, all existing sources of aircraft location and turnaround status information are transmitted to a common decision support database. A current state of aircraft location and turnaround status is maintained in the decision support database and information on all previous states is archived. A suite of new and existing management applications and expert systems are then used to view and analyze the data. Airport and airline management identify problems and optimize responses using the new and existing management applications and expert systems. Decisions are then communicated to the various organizations and functions to enhance management of airport operations, such as implementing the turnaround process of the aircraft.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of this invention will be described in detail, with reference to the following figures, wherein:

FIG. 1 is a data flow diagram illustrating one exemplary embodiment of an airport management architecture according to this invention;

FIG. 2 illustrates a first embodiment of a ramp and gate situation graphical user interface according to this invention;

FIG. 3 illustrates a second exemplary embodiment of a ramp and gate situation graphical user interface according to this invention;

FIG. 4 illustrates one exemplary embodiment of a ground control graphical user interface according to this invention;

FIG. 5 is a block diagram of one exemplary embodiment of an airport operations managing system according to this invention; and

FIG. 6 is a top level flowchart representing the process of managing airport operations according to an exemplary embodiment of the invention.

### DETAILED DESCRIPTION OF EXEMPLARY EMBODIMENTS

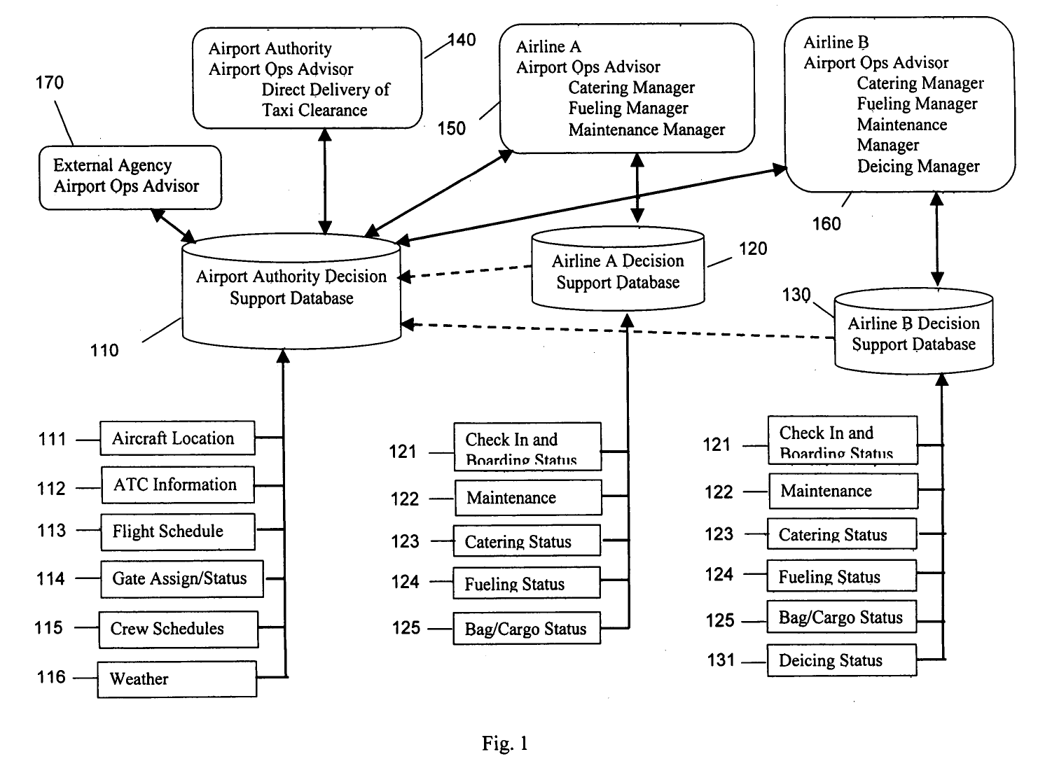

FIG. 1 is a data flow diagram illustrating one exemplary embodiment of an airport management architecture according to this invention. The airport decision support database 110 shown in FIG. 1 contains shared status information from all of the activities at the airport. This shared status information includes public status information generated by activities managed by the airport, such as aircraft location 111, air traffic control (ATC) information 112, flight schedules 113, gate assignment/status 114, crew schedules 115 and weather 116. The shared status information also includes status information generated by the airlines using the airport that they elect to share with the other airport operations centers to enhance efficiency.

Aircraft location 111 may be determined using methods and systems described in patents '611, '912, '320, '342, '965, '363 and '692, multilateration technology or any other existing or to be developed method. The format/protocol of the aircraft location 111 is translated from that used when it is determined into a standard format/protocol used by the Airport Authority Decision Support Database 110. The aircraft location 111 is then sent to the Airport Authority Decision Support Database 110. It should be appreciated that the aircraft location 111 can be transmitted to the Airport Authority Decision Support Database 110 first and then format/protocol translation can be performed by the Airport Authority Decision Support Database 110. It should also be appreciated that the method used for determining aircraft location can be designed to use the standard format/protocol of the Airport Authority Decision Support Database 110.

ATC information 112 such as flight clearances and flight restrictions is generated and maintained by ATC using existing ATC systems. The format/protocol of ATC information 112 is translated from that used when it is generated into a standard format/protocol used by the Airport Authority Decision Support Database 110. The ATC information 112 is then sent to the Airport Authority Decision Support Database 110. It should be appreciated that the ATC information 112 can be transmitted to the Airport Authority Decision Support Database 110 first and format/protocol translation can be performed by the Airport Authority Decision Support Database 110.

Flight schedules 113 and gate assignment/status 114 and crew schedules 115 are generated by the Airport Operations Center. The format/protocol of the flight schedules 113 and gate assignment/status 114 and crew schedules 115 are translated from that used when they are generated into a standard format/protocol used by the Airport Authority Decision Support Database 110. The flight schedules 113 and gate assignment/status 114 and crew schedules 115 are then sent to the Airport Authority Decision Support Database 110. It should be appreciated that the flight schedules 113 and gate assignment/status 114 and crew schedules 115 can be transmitted to the Airport Authority Decision Support Database 110 first and format/protocol translation can be performed by the Airport Authority Decision Support Database 110.

Weather information 116 is typically provided by an external agency and is transmitted to the Airport Authority Decision Support Database 110. The format/protocol of the weather information 116 is translated by the Airport Authority Decision Support Database 110 after receipt. It should be appreciated that some airports or airlines can have their own weather information 116 service.

In the embodiment shown in FIG. 1, Airline A has its own, or contracts for, check-in, boarding, maintenance, catering, fueling, bag handling and cargo handling functions. Check-in and boarding status 121, maintenance status 122, catering status 123, fueling status 124, and bag and cargo handling status 125 for Airline A is generated by these separate functions and transmitted to the Airline A Decision Support Database 120. Any status information stored in the Airline A Decision Support Database 120 which Airline A elects to share with the other airport operations centers to enhance efficiency is then transmitted to the Airport Authority Decision Support Database 110, as shown by the dashed line.

For those support functions without an existing automated status system, a system that generates information formats compatible with the Airline A Decision Support Database 120 is installed. Those functions with existing automated tracking systems, are modified to use compatible data format/protocols or translated to compatible format/protocols used by the Airline A Decision Support Database 120. It should be appreciated that existing automated tracking systems can be used as is and data format/protocol translation can be performed at the Airline A Decision Support Database 120 after the data is received.

In the embodiment shown in FIG. 1, Airline B has its own, or contracts for a, de-icing function in addition to the check-in, boarding, maintenance, catering, fueling, bag handling and cargo handling functions shown for Airline A. The de-icing status 131, check-in and boarding status 121, maintenance status 122, catering status 123, fueling status 124, and bag and cargo handling status 125 for Airline B is generated by these separate functions and transmitted to the Airline B Decision Support Database 130. Any status information stored in the Airline B Decision Support Database 130 which Airline B elects to share with the other airport operations centers to enhance efficiency is then transmitted to the Airport Authority Decision Support Database 110, as shown by the dashed line.

For those support functions without an existing automated status system, a system that generates information formats compatible with the Airline B Decision Support Database 130 is installed. Those functions with existing automated tracking systems, are modified to use compatible data format/protocols or translated to compatible format/protocols used by the Airline B Decision Support Database 130. It should be appreciated that existing automated tracking systems can be used as is and data format/protocol translation can be performed at the Airline B Decision Support Database 130 after the data is received.

The Airport Authority Airport Operations Advisor 140, shown in FIG. 1, is a surface operations management tool used in the airport authority operations center to provide realtime command and control. The Airport Authority Operations Advisor 140 has graphical and text user interfaces and applications for managing functions controlled by the Airport Authority, such as direct delivery of taxi clearances, for example. The Airport Authority Operations Advisor 140 interfaces with the Airport Authority Decision Support Database 110 to obtain shared status information for its graphical displays and to distribute command directives to airport services.

The External Agency Airport Operations Advisor 170 is a surface operations management tool used by an external agency such as the FAA to monitor Airport status. The External Agency Airport Operations Advisor 170 is essentially another instance of the Airport Operations Advisor used by the Airport Authority, with the same core system, graphical user interfaces, text user interfaces as the Airport Authority Airport Operations Advisor 140. The External Agency Airport Operations Advisor 170 interfaces with the Airport Authority Decision Support Database 110 to obtain shared status information.

The Airline A Airport Operations Advisor 150 is a surface operations management tool used in the Airline A operations center to provide realtime command and control. The Airline A Airport Operations Advisor 150 is essentially another instance of the Airport Operations Advisor program used by the Airport Authority and has the same core system, graphical user interfaces and text user interfaces as the Airport Authority Airport Operations Advisor 140. The Airline A Operations Advisor 150 interfaces with the Airport Authority Decision Support Database 110 to obtain shared status information and interfaces with the Airline A Decision Support Database 120 to obtain Airline A proprietary information for its graphical displays and to distribute command directives to airport services. The Airline A Airport Operations Advisor 150 has different management applications than the Airport Authority Airport Operations Advisor 140, such as a catering manager, fueling manager and maintenance manager needed to control Airline A's specific support functions.

The Airline B Airport Operations Advisor 160 is a surface operations management tool used in the Airline B operations center to provide realtime command and control. The Airline B Airport Operations Advisor 160 is essentially another instance of the Airport Operations Advisor used by the Airport Authority and Airline A, with the same core system, graphical user interfaces, text user and management applications as the Airline A Airport Operations Advisor 150. The Airline B Operations Advisor 160 interfaces with the Airport Authority Decision Support Database 110 to obtain shared status information and interfaces with the Airline B Decision Support Database 130 to obtain Airline B proprietary information for its graphical displays and to distribute command directives to airport services. The Airline B Airport Operations Advisor 160 includes additional management applications not used by the Airline A Airport Operations Advisor 150, such as a deicing manager.

It should be appreciated that the airport management architecture shown in FIG. 1 is not restricted to exactly Airline A and Airline B, and can also be utilized with no Airlines integrated, one airline or more than two. It should also be appreciated that the specific list of support functions for which status is gathered and/or the Airport Operations Advisor contains a manager application, can vary for the Airport Authority or any of the airlines.

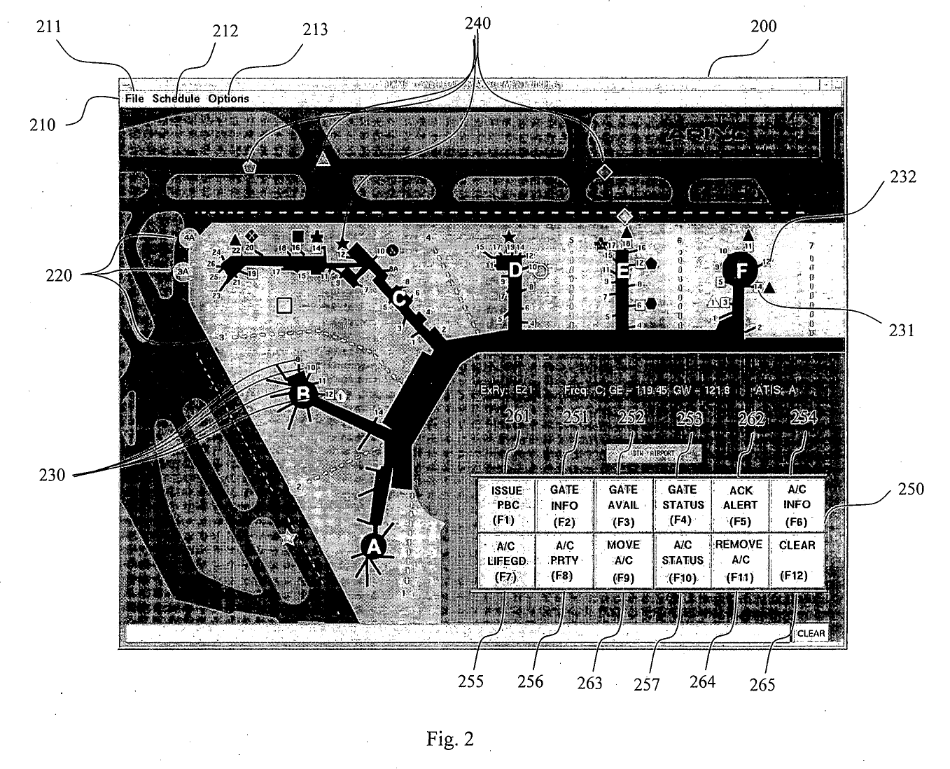

FIG. 2 illustrates one exemplary one embodiment of a ramp and gate situation graphical user interface 200 according to this invention. The ramp and gate situation graphical user interface 200 is the top-level display used by an operator to access the Airport Operations Advisors functions. The preferred embodiment of the ramp and gate situation graphical user interface 200 has a menu bar 210 containing File 211, Schedule 212 and Options 213 topics. The File 211 topic contains the Exit sub-topic, used to close the instance of the Airport Operations Advisor being viewed. The Schedule 212 topic contains the Master Flight Schedule and Airline Schedule sub-topics. The Master Flight Schedule sub-topic displays a schedule of all aircraft arrivals and departures for the airport when selected. The Airline Schedule sub-topic displays a schedule of aircraft and support equipment for a specific airline. Although the graphical user interface 200 has a menu bar 210 containing File 211, Schedule 212 and Options 213 topics, it should be understood that other topics are contemplated by this invention.

The Options 213 topic shown in FIG. 2 has a query sub-topic and a configure sub-topic. The query sub-topic is selected to retrieve status information from the decision support database. Lower tier menu selections of the query sub-topic, such as fueling, baggage, catering or other support function are selected to narrow the information search. Queries can be made for the present state of a support function or for a historical log of that support function status. The configure sub-topic is selected to implement airport management decisions. Lower tier menu selections of the configure sub-topic are selected to reconfigure or allocate assets used by the airport support functions. Although a query sub-topic and a configure sub-topic are discussed in this exemplary embodiment, it should be understood that other sub-topics are contemplated by this invention.

The ramp and gate situation graphical user interface 200 shows the location of each ramp 220, shown in FIG. 2 with a numbered gray circle. The location of each gate 230 is shown with a numbered square. Assigned gates 231 are white and available gates 232 are gray. Aircraft 240 are shown with symbols of various shapes, each shape identifying a different type of aircraft. The status of the aircraft 240 is indicated by the shape's color when in use, i.e., blue for boarding or in service and red for resource conflict.

The function buttons 250 are used as short cuts to some of the sub-topics in the options 213 topic of the menu. The gate info 251, gate avail 252, gate status 253, aircraft (A/C) info 254, A/C LifeGD 255, A/C priority 256 and A/C status 257 are types of decision support database queries which can be selected. Issue PBC 261, acknowledge alert 262, move A/C 263, remove A/C 264 and clear 265 are selected to configure resources.

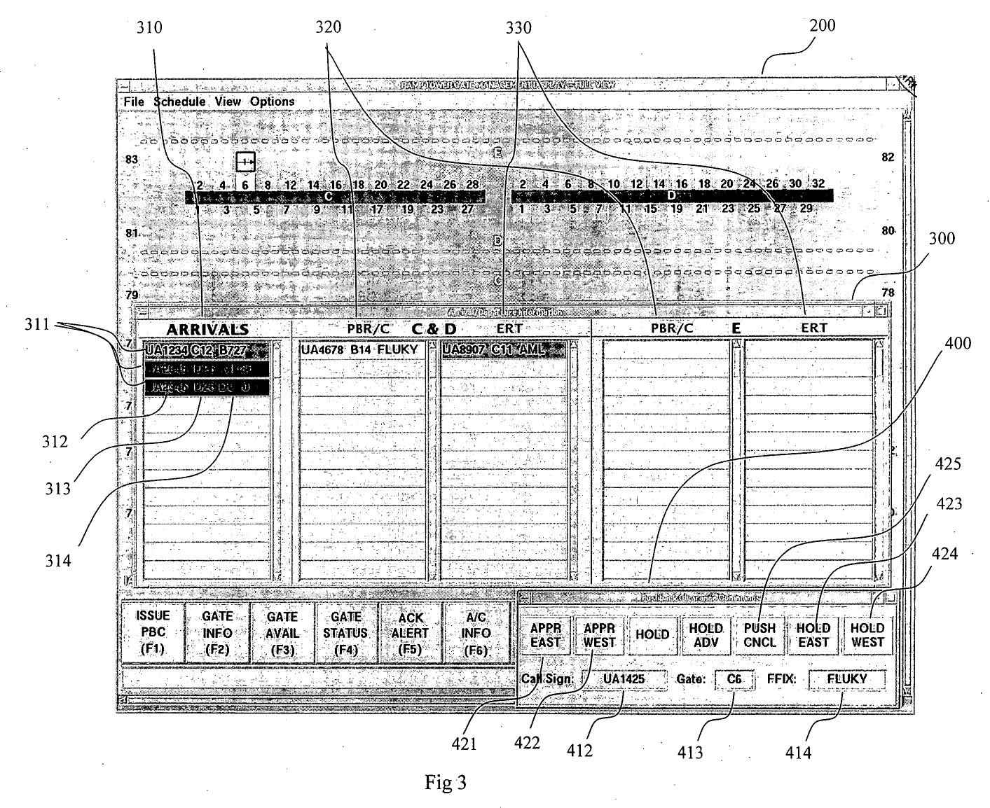

FIG. 3 illustrates a second exemplary embodiment of the ramp and gate situation graphical user interface 200 shown in FIG. 2 that contains two open windows, the arrival/departure information window 300 and the pushback clearance window 400. The arrival/departure information window 300 was opened by the ramp and gate situation graphical user interface 200 when the operator selected the A/C info 254 function. The arrival/departure information window 300 includes an arrivals column 310, which lists arriving aircraft 311. Each arriving aircraft 311 in the arrivals column 310 is listed in a separate row and includes aircraft call sign 312, gate assignment 313 and aircraft type 314. The arrival/departure information window 300 also includes a PBR/C column 320 and a ERT column 330 for each ramp C&D and E. The PBR/C column 320 and a ERT column 330 also list each aircraft in a separate row and includes call sign 312, gate assignment 313 and aircraft type 314.

In the exemplary embodiment shown in FIG. 3, the pushback clearance window 400 was opened by the ramp and gate situation graphical user interface 200 when the operator selected the issue PBC 261 function. The pushback clearance window 400 contains the call sign 412, gate assignment 413 and aircraft type 414 of the aircraft requesting pushback clearance. An operator can give clearance to approach east 421 approach west 422, hold east 423 hold west 424 or cancel 425 the pushback request by selecting the designated button. Once the operator selects a button the Airport Operations Advisor transmits this direction to the decision support database and all airport and airline systems which need to respond.

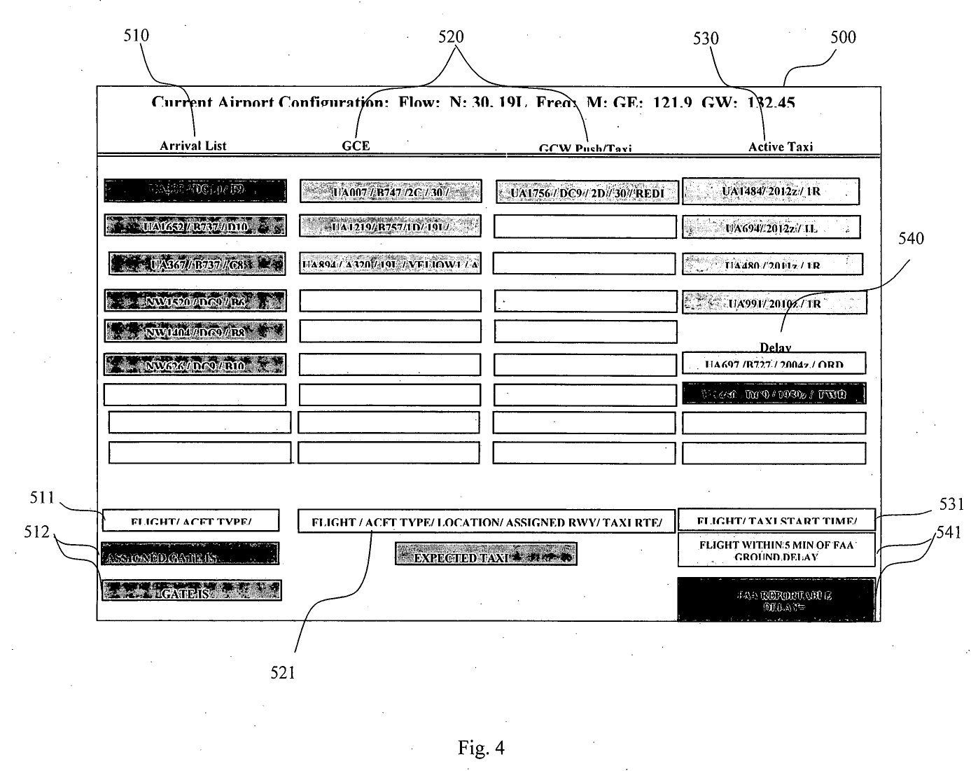

FIG. 4 illustrates one exemplary embodiment of a ground control graphical user interface according to this invention. The ground control graphical user interface 500 shown in FIG. 4 is a passive information tool used to manage airport ground traffic. The arrival list 510 is contained in the first column of the ground control graphical user interface 500. Each row of the arrival list 510 represents an aircraft arriving on the ground at the airport and provides flight call sign, aircraft type and gate, as shown in the legend 511. Gate status for each arriving aircraft is determined by the row color as shown in the legend 512.

The pushback list 520 is contained in the middle two columns of the ground control graphical user interface 500. Each row of the pushback list 520 represents an aircraft awaiting clearance to pushback and taxi and provides flight call sign, aircraft type, location, assigned runway, taxi route and ATIS (Automatic Terminal Information Service), as shown in the legend 521. The active taxi list 530 is contained in the last column of the ground control graphical user interface 500. Each row of the active taxi list 530 represents an aircraft taxing to takeoff and provides flight call sign, taxi start time and runway, as shown in the legend 531. The delay list 540 is contained in the last column of the of the ground control graphical user interface 500. Each row of the delay list 540 represents an aircraft whose taxi clearance has been delayed. The status of the delay is indicated, as shown in the legend 541.

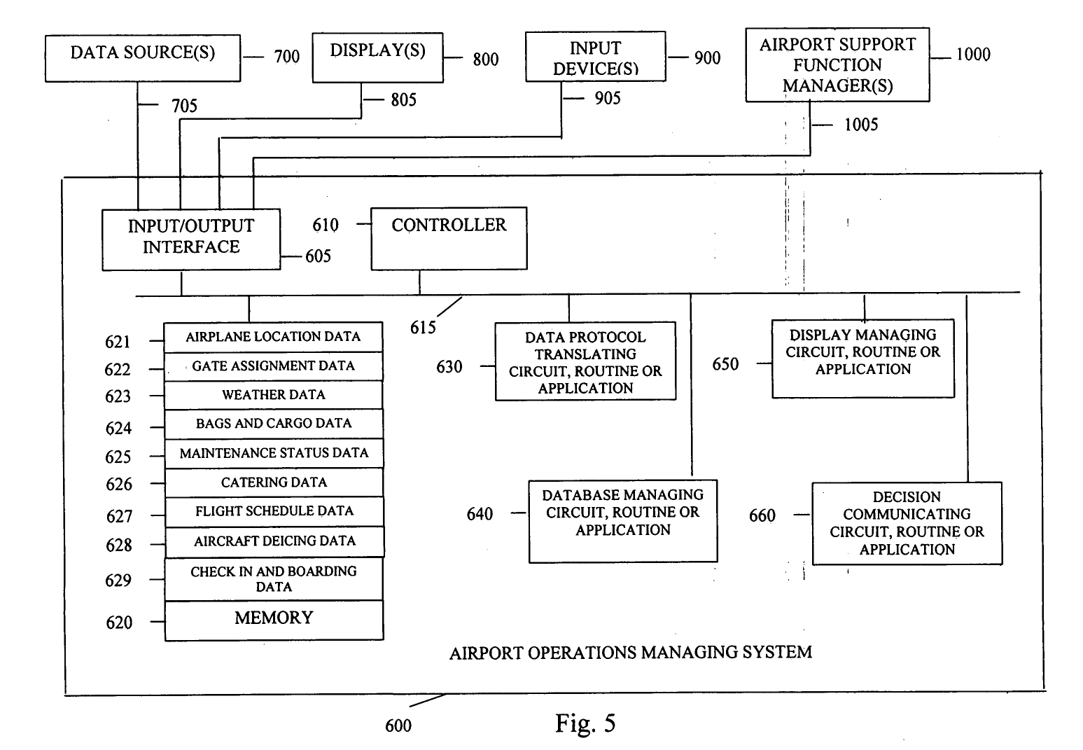

FIG. 5 shows one exemplary embodiment of an airport operations managing system 600 according to this invention. As shown in FIG. 5, the airport operations managing system 600 includes an input/output interface 605, a controller 610, a memory 620, a data protocol translating circuit, routine or application 630, a database managing circuit, routine or application 640, a display managing circuit, routine or application 650 and a decision communicating circuit, routine or application 660, interconnected by a control/data bus 615.

As shown in FIG. 5, one or more data sources 700, one or more displays 800, one or more user input devices 900, and one or more airport support function managers 1000 are connected to the airport operations managing system 600 by the links 705, 805, 905 and 1005, respectively.

In general, the one or more data sources 700 shown in FIG. 5 can be any known or later developed device that is capable of providing status information on the one or more airport support function managers 1000 to the airport operations managing system 600 of this invention. In general, the one or more airport support function managers 1000 shown in FIG. 5 can be any known or later developed system that is used to manage various airport and airline support functions necessary to service or operate an airport or airplane.

The one or more data sources 700 and the one or more airport support function managers 1000 can be integrated into one or more systems. The one or more data sources 700 and the one or more airport support function managers 1000 can also be integrated directly into the airport operations managing system 600. It should be appreciated that the one or more data sources 700 and one or more airport support function managers 1000 need not be integrated in the same way.

Each of the respective one or more displays 800 may be one or any combination of multiple display devices, such as a CRT, a LCD, LED array, or any other known or later-developed device for displaying information provided by the airport operations managing system 600 of this invention. It should be understood that the one or more display devices 800, of FIG. 5 do not need to be the same type of device.

Each of the respective one or more user input devices 900 may be one or any combination of multiple input devices, such as a keyboard, a mouse, a joy stick, a trackball, a touch pad, a touch screen, a pen-based system, a microphone and associated voice recognition software, or any other known or later-developed device for inputting user commands to the airport operations managing system 600. It should be understood that the one or more user input devices 900 of FIG. 5 do not need to be the same type of device.

Each of the links 705, 805, 905 and 1005 connecting the airport operations managing system 600 to the one or more data sources 700, the one or more user input devices 800, the one or more displays and the one or more airport support functions managers 1000, can be a direct cable connection, a modem, a local area network, a wide area network, and intranet, the Internet, any other distributed processing network, or any other known or later developed connection device. It should be appreciated that either of these links 705, 805, 905 and 1005 may include wired or wireless portions. In general, each of the links 705, 805, 905 and 1005 can be of any known or later-developed connection system or structure usable to connect the respective devices to the airport operations managing system 600. It should be understood that the links 705, 805, 905 and 1005 do not need to be of the same type.

As shown in FIG. 5, the memory 620 can be implemented using any appropriate combination of alterable, volatile, or non-volatile memory or non-alterable, or fixed memory. The alterable memory, whether volatile or non-volatile, can be implemented using any one or more of static or dynamic RAM, a floppy disk and disk drive, a writable or rewritable optical disk and disk drive, a hard drive, flash memory or the like. Similarly, the non-alterable or fixed memory can be implemented using any one or more of ROM, PROM, EPROM, EEPROM, and gaps an optical ROM disk, such as a CD-ROM or DVD-ROM disk and disk drive or the like.

Each of the various embodiments of the airport operations managing system 600 can be implemented as software executed on a programmed general purpose computer, a special purpose computer, a microprocessor or the like. It should also be understood that each of the circuits, routines, applications or managers shown in FIG. 5 can be implemented as portions of a suitably programmed general-purpose computer. Alternatively, each of the circuits, routines, applications or managers shown in FIG. 5 can be implemented as physically distinct hardware circuits within an ASIC, using a digital signal processor (DSP), using a FPGA, a PDL, a PLA and/or a PAL, or using discrete logic elements or discrete circuit elements. The particular form of the circuits, routines, applications or managers shown in FIG. 5 will take is a design choice and will be obvious and predictable to those skilled in the art. It should be appreciated that the circuits, routines or managers shown in FIG. 5 do not need to be of the same design.

When operating the airport operations managing system 600, airport support function status can be input from one of the data sources 700 over the link 705, as shown in FIG. 5. The input/output interface 605 inputs airport support function status, and under the control of the controller 610, forwards it to the data protocol translating circuit, routine or application 630. It should be appreciated that if the input airport support function status information is known to be in a compatible format it can be sent directly to the appropriate portion of the memory 620.

The data protocol translating circuit, routine or application 630 then checks to see if the input airport support function status information is in a compatible protocol or format compatible with the database in the airport operations managing system 600 memory 620. If the input airport support function status information is not in a compatible format data protocol translating circuit, routine or application 630 translates the input airport support function status information into a compatible format. The data protocol translating circuit, routine or application 630 then outputs the translated the input airport support function status information to the database managing circuit, routine or application 640 or stores it in the appropriate portion of the memory 620 under the control of the controller 610.

If the database managing circuit, routine or application 640 receives the input airport support function status information directly, it stores it in the appropriate portion of the memory 620, under the control of the controller. The database managing circuit, routine or application 640 then sends the input airport support function status information to the display managing circuit, routine or application 650, under the control of the controller 610. The display managing circuit, routine or application 650 then updates the information in any active display windows by sending the input airport support function status information to one or more of the displays 800 over the link 805, under the direction of the controller 610.

When operating the airport operations managing system 600, information requests can be input from one or more of the input devices 900 over the link 905, as shown in FIG. 5. The input/output interface 605 inputs the information request, and under the control of the controller 610, forwards it to the database managing circuit, routine or application 640. The database managing circuit, routine or application 640 retrieves the requested information from the appropriate section of the memory 620. The database managing circuit, routine or application 640 sends the retrieved information to the display managing circuit, routine or application 650. The display managing circuit, routine or application 650 generates any needed windows or displays and sends the generated windows and the retrieved information to one or more of the displays 800 over the link 805, under the direction of the controller 610.

When operating the airport operations managing system 600, reconfiguration commands can be input from one or more of the input devices 900 over the link 905, as shown in FIG. 5. The input/output interface 605 inputs the reconfiguration command, and under the control of the controller 610, forwards it to the decision communicating circuit, routine or application 660. The decision communicating circuit, routine or application 660 forwards the reconfiguration command to the one or more of the airport support function managers 1000 over the link 1005 under the direction of the controller. The decision communicating circuit, routine or application 660 also sends any status changes generated by the reconfiguration command to the database managing circuit, routine or application 640. The database managing circuit, routine or application 640 stores the new status information in the appropriate section of the memory 620.

Previously gathered status information is archived in the memory 620. The archived data can be disseminated through reports generated thereon. The archived data may also be used to identify and implement changes that will positively impact the operations of the airport. For example, in the event of a delay, the archived data may be reviewed to determine the state of the airport, location of aircraft, and the like, to determine the cause of the delay and implement changes to minimize the reoccurrence of a similar situation.

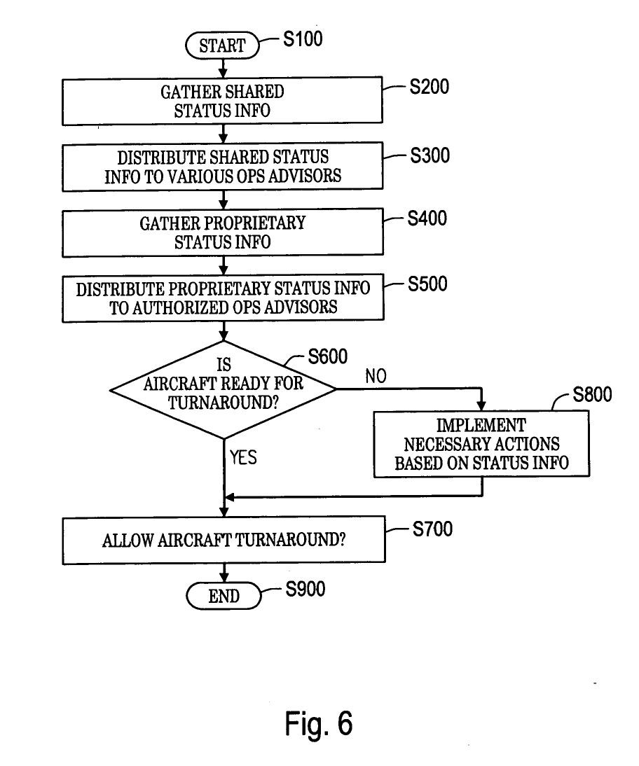

FIG. 6 is a top level flowchart representing an example of managing aircraft turnaround according to an exemplary embodiment of the invention. In FIG. 6, operation begins at step S100 and continues to step S900.

During step S200, shared status information is gathered on all of the activities at the airport and forwarded to the airport authority decision database 110 and archived. For example, shared status information includes aircraft location, flight schedules, gate assignment/status, crew schedules, weather and other such “public” information. Shared status information may also include status information generated by the airlines using the airport that they elect to share with the other airport operations centers to enhance efficiency. Such airline generated information may include for example, check-in and boarding status, de-icing/maintenance progress, catering and fueling status, cargo/baggage loading status, and the like.

During step S300, the shared status information is distributed to various operations advisors. For example, the FAA, or other external agency airport operations advisor 170 using the systems of the invention, may have a need to monitor the status of an airport for overall air traffic safety. The shared information is also distributed to operations advisors 140 within the airport and operations advisors of airlines using the airport 150, 160 to enhance overall efficiency and safety and to expedite aircraft turnaround.

During step S400 proprietary status information is gathered by the airlines, and/or from services contracted to provide such information, and sent to the appropriate airline decision support database 120, 130 where upon the information is archived and forwarded to the appropriate airline operations advisor 150, 160 that has been authorized by the airline to receive such proprietary information. The proprietary information is then used in combination with the shared status information distributed by the airport authority decision database 110 to determine if an aircraft is ready for turnaround, i.e., takeoff, step S600.

It should be appreciated that the information gathered at the various decision support databases and distributed to the various operations advisors is an on-going real-time process. Information is gathered and exchanged continuously. Therefore, the information sent to the operations advisors is dynamic and the decisions based on the most current information available.

If it is determined that the aircraft is ready for turnaround, the aircraft is allowed to turnaround, step S700, and operation proceeds to step S900. In the event a determination is made, based on the current status information provided to the operations advisors, that the aircraft is not ready for turnaround, then the status of the aircraft is monitored to insure that all necessary actions have been completed, step S800. Once the necessary actions have been completed, aircraft turnaround is allowed, step S700, and operation proceeds to step S900.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made to the invention without departing from the spirit and scope thereof.

1. An airport operations managing system that provides decision support for airport operations, comprising:
a first database networked with a first data source usable to obtain and store publicly available status information on the status of airport operations;
a second database networked with a second data source usable to obtain and store non-proprietary airline status information of airline activities, the second database networked with the first database for status information exchange; and
a first airport operations advisor module having at least one of a graphical user interface and a text based interface and usable to manage airport operations, wherein the first airport operations advisor is networked with at least the first database to receive at least one of the publicly available status information and the non-proprietary airline status information, wherein the at least one of the publicly available status information and the non-proprietary airline status information is accessible by airport management and an airline.

2. (canceled)

3. The system of claim 1, wherein the first database includes airline status information of functions proprietary to an airline.

4. The system of claim 1, further comprising a second airport operations advisor module having at least one of a graphical user interface and a text based interface and usable to manage airline operations, wherein the second airport operations advisor is networked with the first database and the second database to receive the shared status information and the airline status information.

5. The system of claim 4, wherein the second airport operations advisor module is networked to the second database to obtain non-proprietary airline information and to distribute airline command directives to the airline.

6. The system of claim 4, further comprising a third airport operations advisor module located at an external agency having at least one of a graphical user interface and a text based interface and usable to monitor airport operations, wherein the third airport operations advisor is networked with the first database to receive the status information from the first database and the second database at the external agency.

7. An airport operations managing system that provides decision support for airport operations, comprising:
a first data source that provides publicly available airport status information, wherein the first data source is connected to an input/output interface;
a second data source that provides non-proprietary airline status information, wherein the second data source is connected to an input/output interface;
a memory connected to the input/output interface via a data bus for storing status information;
a display connected to the input/output interface for viewing status information from the at least one of the first and the second data source by airport management and an airline;
an input device connected to the input/output interface for inputting user commands to the airport operations managing system based on the status information; and
a controller connected to the input/output interface to control the movement of data within the airport operations managing system.

8. The system of claim 7, wherein the status information received from at least one of the first data source and the second data source is routed to a data protocol translating application connected to the data bus under the direction of the controller to be modified to a compatible format and translated status information is output to update information displayed in an active display by sending the status information to the display under the direction of the controller.

9. The system of claim 7, wherein the status information is output to at least one of a database managing application and a display managing application connected to the input/output interface via a data bus, wherein at least one of the database managing application and the display managing application updates information displayed in an active display by sending the airport function status information to the display under the direction of the controller.

10. A method of providing decision support for airport operations, comprising:
gathering status information on at least one aircraft and an airport from at least one data source and storing the status information in a common decision support database accessible by airport management and an airline;
distributing the status information to a display at an airport operations center;
reviewing the status information on the display to identify current status of operations; and
implementing a response based on the status information.

11. The method of claim 10, wherein implementing a response includes determining if an aircraft is ready for takeoff based on the status information.

12. The method of claim 10, wherein gathering the status information comprises gathering at least one of shared status information including public status information generated by activities at an airport, and proprietary information generated by an airline and chosen to be shared.

13. The method of claim 12, wherein gathering the shared status information comprises gathering the status of flight operations and ground services.

14. The method of claim 10, further comprising archiving the status information to provide a historical record for identifying and implementing changes to airport operations.

15. The method of claim 12, wherein at least one of the gathering of status information and distributing status information is done in real-time.

16. A storage medium storing a set of program instructions executable on a data processing device and usable to provide decision support for airport operations, the set of program instructions comprising:
instructions for gathering status information on at least one aircraft and an airport from at least one data source and storing the status information in a common decision support database accessible by airport management and an airline;
instructions for distributing the status information to a display at an airport operations center;
instructions for reviewing the status information on the display to identify current status of operations; and
instructions for implementing a response based on the status information.
